(19) United States
(12) Patent Application Publication
(10) Pub. No.: US 2013/0183868 A1
(43) Pub. Date: Jul. 18, 2013

(54) ELECTRICAL CONNECTOR, ELECTRONIC APPARATUS USING THE SAME, AND ASSEMBLING METHOD OF THE ELECTRICAL CONNECTOR

(71) Applicant: ANT PRECISION INDUSTRY CO., LTD., Taipei City (TW)

(72) Inventor: Chih-Yu HSUEH, Taipei City (TW)

(73) Assignee: ANT PRECISION INDUSTRY CO., LTD., Taipei City (TW)

(21) Appl. No.: 13/664,351

(22) Filed: Oct. 30, 2012

Related U.S. Application Data
(60) Provisional application No. 61/586,713, filed on Jan. 13, 2012.

(51) Int. Cl. H01R 24/60

(52) U.S. Cl. CPC H01R 24/60
USPC 439/676

(57) ABSTRACT

An electrical connector, an electronic apparatus using the same, and an assembling method of the electrical connector are introduced herein. The electrical connector includes first set terminals, second set terminals, and an insulated housing which has a plurality of first set terminal passages and second set terminal passages for respectively disposing said first and second terminals therein. When an elastic contact section of the respective first set terminal contacts with a complementary electrical connector, at least one elastic supporting section of the respective first set terminal provides flexibility required for the elastic contact section so that the elastic contact section can limitedly and elastically move within the corresponding first set terminal passage

### BACKGROUND OF THE INVENTION

1. Field of the Invention

The present invention generally relates to an electrical connector, an electronic apparatus using the same, and an assembling method of the electrical connector; particularly, the present invention relates to a terminal structure of an electrical connector having better contact elasticity.

2. Description of the Related Art

Presently, the development of signal transmission standards of Universal Serial Bus (USB) has reached USB version (3.0). Electrical connectors in compliance with USB 3.0 standards not only can selectively electrically connect a USB 3.0 complementary electrical connector, but may also selectively electrically connect electrical connectors in compliance with USB 1.0/2.0 standards so that signal transmissions complying with the USB 1.0/2.0 standards may be conducted. In order to allow the USB 3.0 electrical connector to be compatible with USB 1.0/2.0 standards, the USB 3.0 electrical connector has a structure with a plurality of terminal sets. For instance, there may be at least a set of terminals for transmitting USB 1.0/2.0 signals, and a set of terminals for transmitting USB 3.0 signals.

Some examples of conventional USB 3.0 electrical connectors, such as Taiwan patent M346198, M346941, M348358, M357776, M366783, M370859, M376015, M405081, 200945689, 201125228, 201112540, and U.S. Pat. No. 7,972,151, U.S. Pat. No. 7,927,145, and U.S. Pat. No. 7,833,065, are primarily featured with a plurality of structures of terminals, an insulation body for carrying the structures of terminals, and a metallic shielding casing to house the insulation body. Due to the fact that the insulation body includes a plurality of discrete plastic elements, each discrete element needs to be manufactured individually and then assembled together in order to secure the aforementioned structures of terminals in the different layers within the assembled insulation body. However, this type of complicated and small-dimensional structure would not only require the use of many different molds to manufacture, the assembly tolerance and the difficulties involved in the assembling process would also be increased and cause the product yield to be decreased, which results in higher manufacturing costs. In addition, each USB 3.0 terminal of the mentioned structure of plurality of terminal sets includes a contact section whose surface evenly contact or is fixed on a wall surface of a corresponding passage on the insulation body so that there is no elasticity for mating. In this manner, when corresponding terminals of a complementary electrical connector is inserted into the conventional USB 3.0 electrical connectors to press against another corresponding surface of those contact sections, since the terminals lack any elasticity for buffering purposes, the structure of the USB 3.0 terminals is likely to be damaged by the direct strike during mating.

In other conventional USB 3.0 electrical connectors, such as Taiwan Patents M329880, M329877, M359066, M366792, M379191, 200910693, and U.S. Pat. No. 7,517,253, U.S. Pat. No. 7,625,243, U.S. Pat. No. 7,641,519, U.S. Pat. No. 7,736,184, U.S. Pat. No. 7,806,704, U.S. Pat. No. 7,806,735, U.S. Pat. No. 7,833,065, U.S. Pat. No. 7,837,510, U.S. Pat. No. 7,862,346, U.S. Pat. No. 8,002,589, U.S. Pat. No. 8,052,477, US2010/0322566, and US2011/0143599, although the complicated structure of the insulation body has been simplified slightly, the contact sections of the USB 3.0 terminals of the insulation body similarly includes a surface evenly contact or is fixed to a wall surface of a corresponding passage on the insulation body. When the corresponding terminals of the complementary electrical connector is inserted into the USB 3.0 electrical connector to electrically contact another corresponding surface of these contact sections, the structure of the USB 3.0 terminals is similarly likely to be damaged by the direct strike.

### SUMMARY OF THE INVENTION

In order to solve the above problem of the prior art, it is an object of the present invention to provide an electrical connector featured with a terminal structure comprising an elastic contact section and at least one elastic/non-elastic support section. When the corresponding terminals of a complementary electrical connector electrically contacts the elastic contact section, the at least one elastic/non-elastic support section may provide better contact elasticity so that damaging the terminal structure may be prevented.

In order to achieve the above objectives, a preferred embodiment of the present invention provides an electrical connector for use in electrically connecting with a complementary electrical connector. The structure of the electronic connector includes a first terminal set, a second terminal set, an insulation body, and a positioning part.

The first terminal set includes a pair of first differential signal terminals and a pair of second differential signal terminals. The second terminal set includes a pair of third differential signal terminals. Each terminal of the first terminal set and the second terminal set has an elastic contact section, at least one elastic support section, at least one holding section, and a soldering pin section. For the first terminal set, two opposing sides of the elastic contact section respectively extend outward to form at least one wing section. For the first terminal set, the at least one elastic support section is connected to the elastic contact section, wherein at least a bend is formed at the connection point with the elastic contact section.

The insulation body has a base part and a mating part that extends outward from the base part to an end. A mating surface is formed on the mating part to correspond to the connection of the complementary connector. The insulation body comprises a plurality of first terminal set passages and a plurality of second terminal set passages to be respectively configured with the first terminal set and the second terminal set. The first terminal set passage and the second terminal set passage extend to the base part and mating part of the insulation body, wherein the first terminal set passage extends and passes through an end of the mating part, and at least one blocker is formed in at least one inner side wall of the first terminal set passage to correspond to at least one wing section of the first terminal set.

When the first terminal set and the second terminal set are respectively configured in the first terminal set passage and the second terminal set passage, at least one holding section of the first terminal set and the second terminal set separately fixes the first terminal set and the second terminal set in the first terminal set passage and the second terminal set passage of the insulation body. At least one elastic support section of the first terminal set is located in the first terminal set passage, and the elastic contact section of the first terminal set and the elastic contact section of the second terminal set is distributed on the mating surface of the mating part, wherein the distribution position of the elastic contact section of the first terminal set is closer to the end of the mating part than the distribution position of the elastic contact section of the second terminal set.

When the elastic contact section of the first terminal set of the electrical connector contacts the complimentary connector, at least one elastic support section of the first terminal set provides flexibility the elastic contact section of the first terminal set requires for the elastic contact section of the first terminal set to elastically move within the first terminal set passage. However, at least one blocker of the first terminal set passage will block the movement of the at least one wing section of the elastic contact section of the first terminal set, limiting the elastic movement distance of the elastic contact section of the first terminal set in the up or down directions. In the present embodiment, the at least one blocker of the first terminal set passage includes an upper blocker and a lower blocker. The upper blocker is used for blocking the movement of the at least one wing section within the first terminal set passage in the upward direction, limiting the upward elastic movement distance of the elastic contact section of the first terminal set. The lower blocker is used for blocking downward movement of the at least one wing section to limit the downward elastic movement distance of the elastic contact section of the first terminal set.

The positioning part is disposed on the base part of the insulation body, and the soldering pin section of the first terminal set and the soldering pin section of the second terminal set extend outward of the base part of the insulation body and pass through the positioning part.

According to another preferred embodiment of the electrical connector, the first terminal set further includes an elastic slice section which is a bend starting from the elastic contact section and extending towards the mating surface of the insulation body. The elastic slice section is used for contacting the complementary electrical connector.

According to another embodiment of the electrical connector, at least one bend of the first terminal set is exposed out of the end of the mating part of the insulation body.

According to yet another embodiment of the electrical connector, the at least one elastic support section of the first terminal set includes a first elastic support section and a second elastic support section. The second elastic support section is pre-compressed and connecting against a sidewall in the first terminal set passage. The at least one bend includes a first bend and a second bend, wherein the first bend is formed on the connection between the first elastic support section and the elastic contact section, and the second bend is formed on the connection between the second elastic support section and the elastic support section.

According to another embodiment of the electrical connector, each terminal of the first terminal set has an elastic contact section and at least one support section. A portion of the at least one support section is fixed within the first terminal set passage, wherein at least one bend is formed in the connection between the elastic contact section of the first terminal set and the at least one support section. In this manner, the elastic contact section of the first terminal set elastically moves within the first terminal set passage, using the connection between the elastic contact section and the at least one support section as a fulcrum. The two opposing sides of each elastic contact section of the first terminal set separately extend outward to form at least one wing section, and at least one blocker is formed in at least one inner sidewall of each first terminal set passage of the insulation body to correspond to the at least one wing section. When the first terminal set is accommodated in the corresponding first terminal set passage, at least one blocker of the first terminal set passage is used for limiting the movement of the at least one wing section of the first terminal set in a vertical direction such that the upward or downward elastic movement distance of the elastic contact section of the first terminal set is restricted, wherein the at least one blocker may also be used to limit movement of at least one support section of the first terminal set in a horizontal direction.

According to another embodiment of the electrical connector, the first terminal set having at least one support section includes an elastic slice section that is a bend formed in the elastic contact section and extends toward the mating surface. The elastic slice section is used for contacting a complementary electrical connector.

According to another embodiment of the present invention, an electronic device is provided that includes the various above mentioned embodiments of the electrical connector.

In addition, according to another embodiment, an assembling method of the electronic connector is provided and includes the following steps:

The first terminal set is loaded into the plurality of first terminal set passages from a first end of the insulation body, wherein the insulation body has a base part and a mating part, the mating part extends outward from the base part to the first end and the mating part comprises a mating surface, and the first terminal set passage has a pair of first differential signal terminals and a pair of second differential signal terminals.

A second terminal set is loaded into a plurality of second terminal set passages of the insulation body. The second terminal set has a pair of third differential signal terminals, wherein each terminal of the first terminal set and the second terminal set has an elastic contact section and at least one support section that is connected to the elastic contact section, and the elastic contact section of the first terminal set is distributed on the mating surface of the mating part. At least one support section of the first terminal set comprises at least one elastic support section. The at least one elastic support section is an elastic arm structure, wherein a portion of the elastic support section is connected against the wall surface of the first terminal set passage to provide elasticity such that the elastic contact section of the first terminal set may elastically move within the first terminal set passage. The elastic contact section of the second terminal set is distributed on the mating surface of the mating part, and the distribution position of the elastic contact section of the first terminal set is closer to the first end of the mating part than the distribution position of the elastic contact section of the second terminal set.

According to another embodiment of the assembling method of the electrical connector, the assembling method includes the following different step: loading the first terminal set into the plurality of first terminal set passages from a second end formed opposite the first end on the insulation body.

According to another embodiment of the assembling method of the electrical connector, the assembling method includes the following different step: when loading each of the first terminal set into the first terminal set passages, the at least one support section comprises a non-elastic support section, the at least one support section fixedly leans against a wall surface of the first terminal set, and a fulcrum is formed in the connection between the at least one support section and the elastic contact section of the first terminal set to make the elastic contact section of the first terminal set to elastically move into the first terminal set passage.

Each terminal structure includes an elastic contact section and at least one elastic/non-elastic support section. When corresponding terminals of a complementary electrical connector electrically contacts against the elastic contact section, the at least one elastic/non-elastic support section can provide better contact elasticity by producing elastic deformation or by providing the fulcrum in order to prevent damage from occurring to the terminal structure. According to the assembling method of the electrical connector, the above simplification of the insulation body structure is not only easy for assembling, it can also increase product yield such that manufacturing costs are decreased.

### BRIEF DESCRIPTION OF THE DRAWINGS

FIG. 1A is an exploded view of the first embodiment of the electrical connector;

FIG. 1B is a view of the insulation body, the first terminal set, and the second terminal set of the electrical connector of the first embodiment;

FIG. 1C is a front view of FIG. 1B;

FIG. 1D is a device cross-section view on the A1-A1′ line of the insulation body of FIG. 1C;

FIG. 2 is a cross-sectional view of the second embodiment of the electrical connector;

FIG. 3 is a cross-sectional view of the third embodiment of the electrical connector;

FIG. 4 is a cross-sectional view of the fourth embodiment of the electrical connector;

FIG. 5 is a cross-sectional view of the fifth embodiment of the electrical connector;

FIG. 6 is a cross-sectional view of the sixth embodiment of the electrical connector;

FIG. 7 is a cross-sectional view of the seventh embodiment of the electrical connector; and

FIG. 8 is a cross-sectional view of the eighth embodiment of the electrical connector.

### DETAILED DESCRIPTION OF THE PREFERRED EMBODIMENT

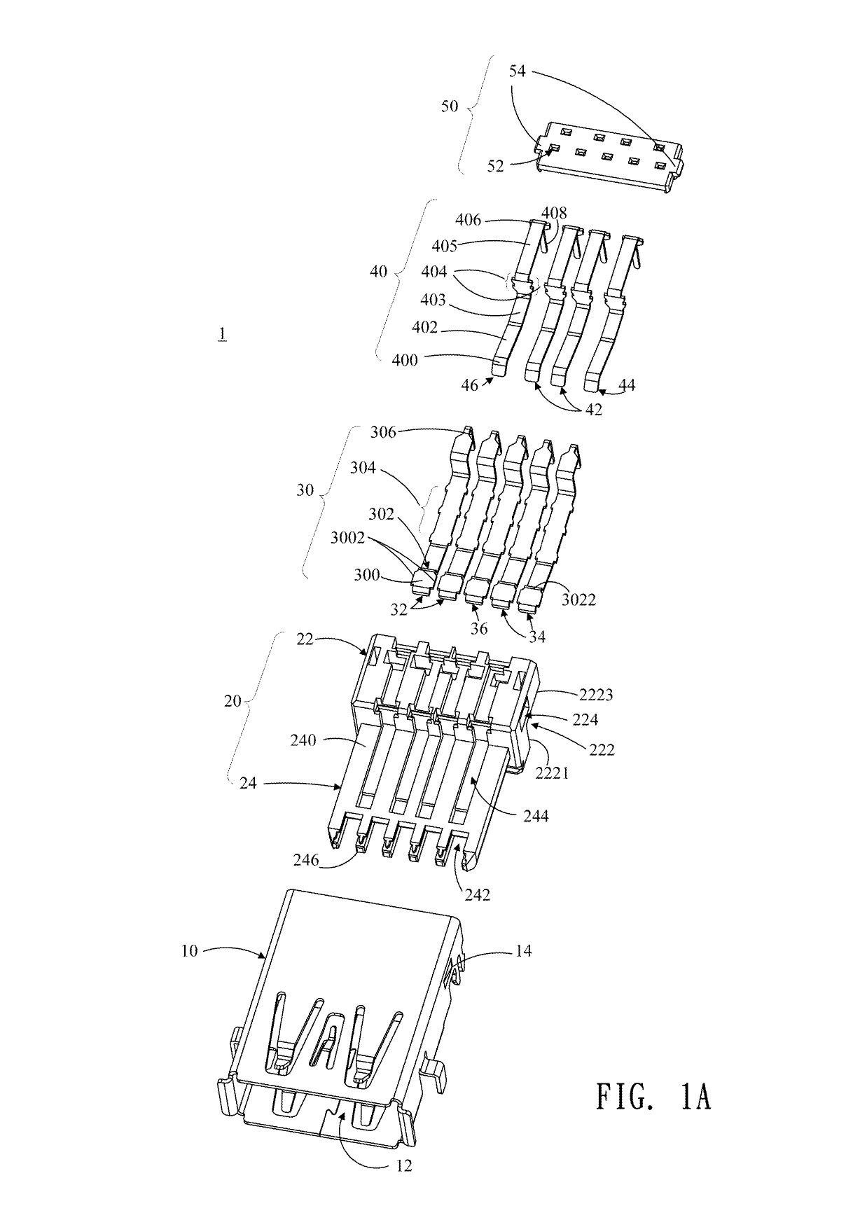

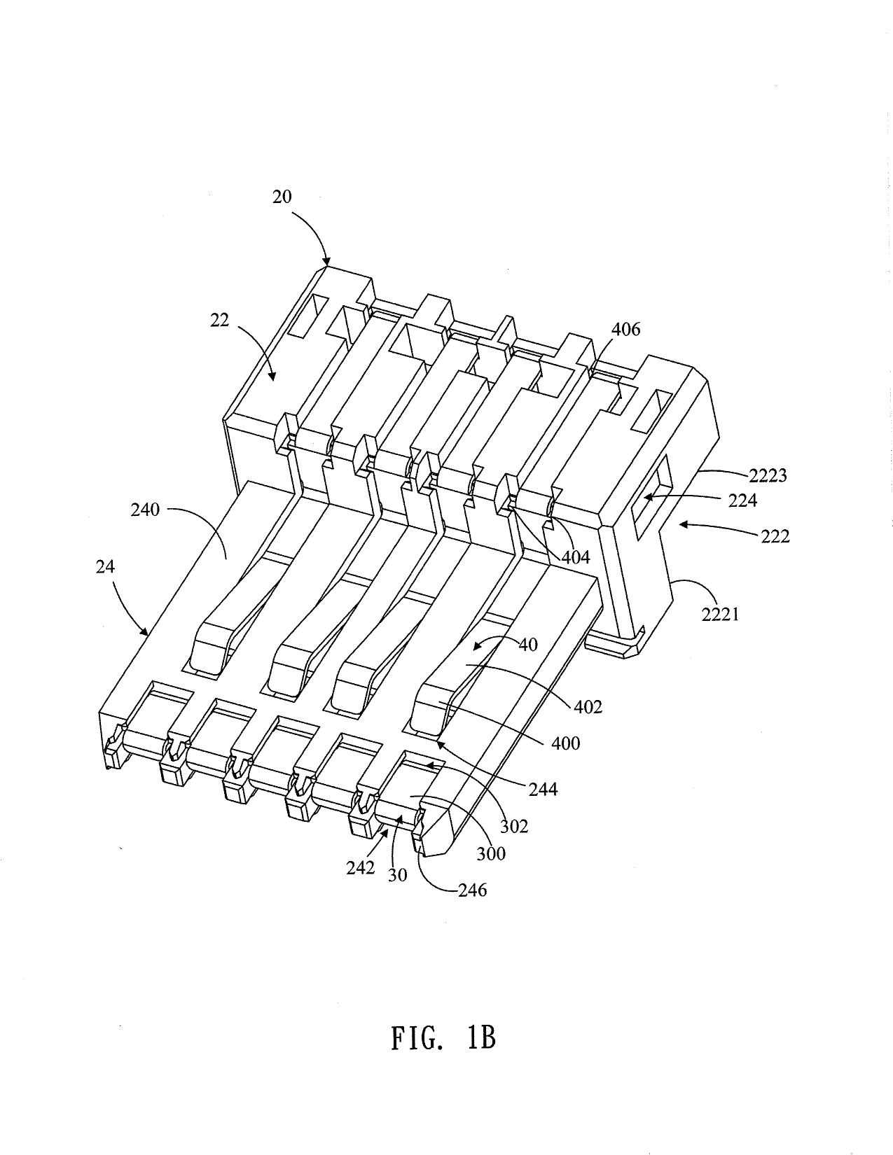

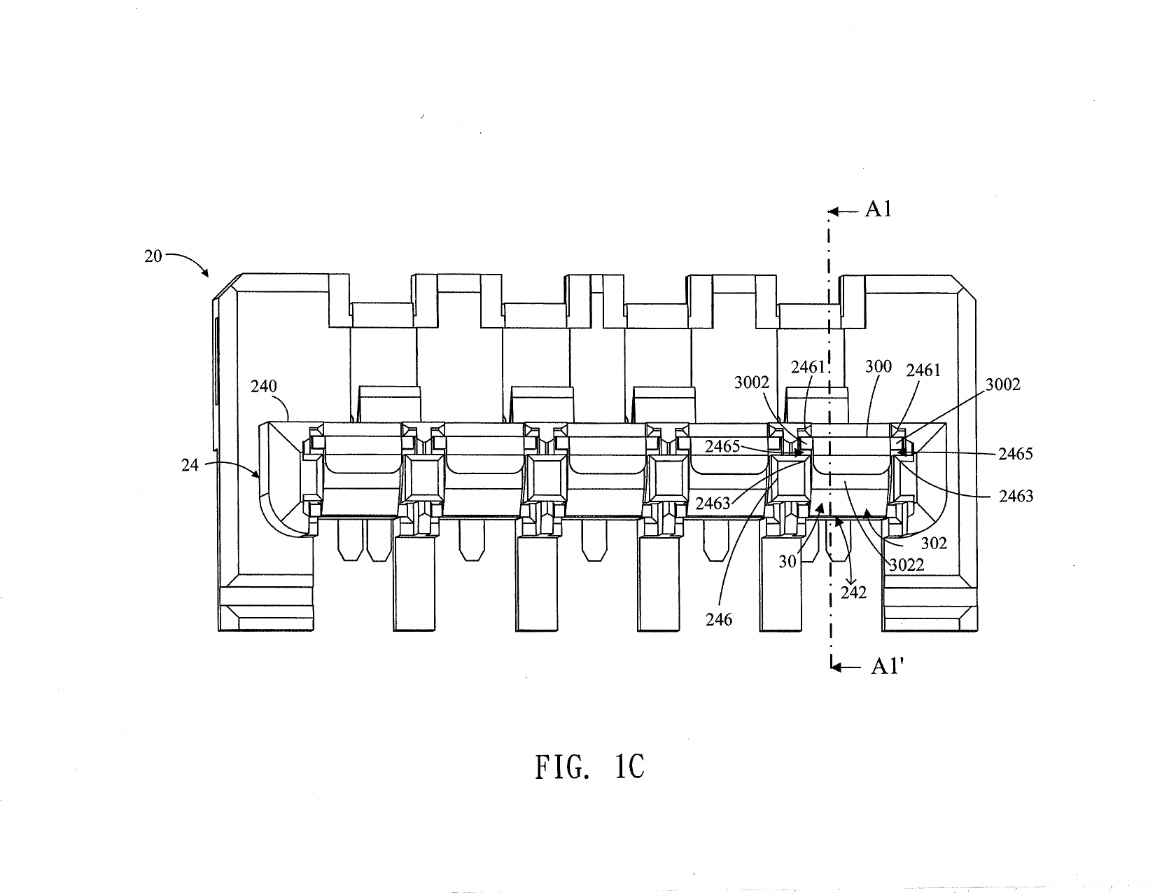

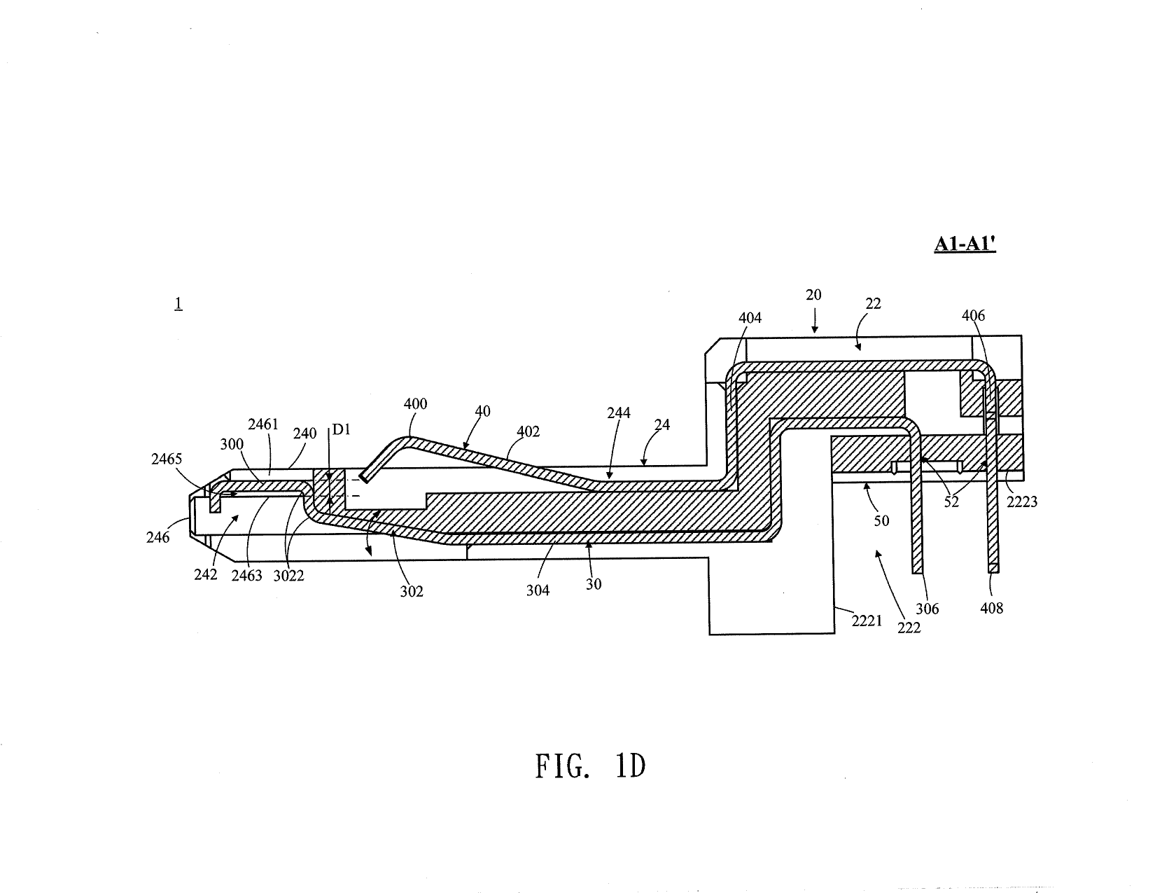

Please refer to FIG. 1A, which illustrates a first embodiment of an electrical connector 1 of the present invention that complies with the USB 3.0 signal transmission stands and is used for electrically connection with a complementary electrical connector (not shown). The electrical connector 1 primarily includes a shielding housing 10, an insulation body 20, a first terminal set 30, a second terminal set 40, and a positioning part 50.

The shielding housing 10 primarily is formed from four wall surfaces, wherein an accommodating space 12 is formed within the confines of the four wall surfaces for accommodating the insulation body 20. A hook 14 is formed recessing inwards on the left and right wall surfaces of the four wall surfaces.

As shown in FIGS. 1A and 1B, in the present embodiment, the entire body of the insulation body 20 is manufactured and formed as a unitary structure with plastic materials. The insulation body 20 includes a base part 22 and a mating part 24, wherein a recessed portion 222 is formed below the base part 22 to accommodate the positioning part 50. A slot 224 is formed on the left and right sides of the base part 22 respectively and is used correspondingly with the hooks 14 of the shielding housing 10 to fix the shielding housing 10 onto the insulation body 20. The mating part 24 extends outward from the front of the base part 22 to a front end 246 along a horizontal direction. A mating surface 240 is formed on the mating part 24 to correspond to the connection of the complementary electrical connector. A plurality of first terminal set passages 242 and a plurality of second terminal set passages 244 are formed on the insulation body 20 to be respectively configured with the corresponding first terminal set 30 and the second terminal set 40. The first terminal set passage 242 extends from the mating part 24 of the insulation body 20 to the base part 22 such that the first terminal set passage 242 is exposed below the mating part 24 and the base part 22 along the direction of extension. An end of the first terminal set passage 242 extends forward and passes through the front end 246 of the mating part 24. The other corresponding end extends backward, passing past a vertical wall surface 2221 of the recessed portion of the base part 22 and then passing downwards through a horizontal wall surface 2223 of the recessed portion 222. The second terminal set passage 244 extends from the upper surface of the mating part 24 of the insulation body 20 to the upper surface of the base part 22 such that the second terminal set passage 244 is exposed above the mating surface 240 of the mating part 24 and above the base part 22 along the direction of extension. The second terminal set passage 244 then extends downward and passes through the horizontal wall surface 2223 of the recessed portion 222 of the base part 22. In further reference to FIGS. 1A and 1C, on two opposing inner sidewalls near the front end 246 of the mating part 24 of each first terminal set passage 242, a pair of upper blockers 2461 and lower blockers 2463 are respectively formed along a vertical direction, wherein the space between each pair of upper blockers 2461 and lower blockers 2463 define a slit 2465.

As shown in FIGS. 1A and 1C, the first terminal set 30 is compatible with the USB 3.0 standards and is separated into a pair of first differential signal terminals 32, a pair of second differential signal terminals 34, and a ground signal terminal 36. Each terminal 32, 34, and 36 of the first terminal set 30 has an elastic contact section 300, an elastic support section 302, a plurality of horizontally directional holding sections 304, and a vertically directional soldering pin section 306. Two opposite sides of the elastic contact section 300 separately extend outward to form two wing sections 3002 to correspond to the two pairs of upper and lower blockers 2461, 2463 within the first terminal set passage 242. Since the front of the elastic support section 302 is connected to the elastic contact section 300 and a plurality of bends 3022 (refer to FIG. 1D) are formed at the connection to the elastic contact section 300, the back of the elastic support section 302 is connected to the plurality of holding sections 304. In this manner, a mechanical structure akin to forming an elastic arm structure that can move up and down can be formed in the space between the elastic support section 302 and the elastic contact section 300. In other embodiments, the first terminal set 30 further includes an elastic slice section (not shown) punched upward in the elastic contact section 300 so that a bend is formed in the connection between the elastic slice section and the elastic contact section 300. The elastic slice section extends towards but does not overpass the mating surface 240 of the insulation body 20. In this manner, greater contact elasticity may be provided for the electrical connector 1 when the electrical connector 1 is plugged or docked.

As shown in FIGS. 1A and 1B, the second terminal set 40 is compatible with the USB 1.0/2.0 standards and is separated into a pair of third differential signal terminals 42, a ground signal terminal 44, and a power signal terminal 46. Each terminal 42, 44, and 46 of the second terminal set 40 has an elastic contact section 400, an elastic support section 402, a horizontally directional first mating part 403, a plurality of vertically directional holding sections 404 and 406, a horizontally directional second mating part 405, and a vertically directional soldering pin section 408. Since the front of the elastic support section 402 is connected to the elastic contact section 400 and the back of the elastic support section 402 is connected along the horizontal direction to the plurality of holding sections 404, an elastic spring arm structure that can move in the upward and downward directions is formed in the space from the elastic support section 402 to the elastic contact section 400. In addition, the holding section 404, the second mating part 405, the holding section 406, and the soldering pin section 408 jointly form a “n” structure, such that it may be disposed on top of the base part 22.

As shown in FIGS. 1C and 1D, when the first terminal set 30 would like to be configured into the first terminal set passage 242, the first terminal set 30 is loaded into the plurality of first terminal set passages 242 in a direction from the front end 246 of the insulation body 20 to the back of the insulation body 20. Then, the holding section 304 of the first terminal set 30 is fixed within the first terminal set passage 343 on the underside of the insulation body 20 so that the elastic support section 302 of the first terminal set 30 is positioned in the first terminal set passage 242 and the position of the elastic contact section 300 of the first terminal set 30 is distributed on the mating surface 240 of the mating part 24 and near the front end 246. In the present embodiment, the elastic contact section 300 of the first terminal set 30 is accommodated within the slit 2465 of the first terminal set passage 242 with the wing sections 3002 on the two sides of the elastic contact section 302 connected against the bottom of the upper blocker 2461. Additionally, a spring arm structure is formed from the elastic support section 302 to the elastic contact section 300. Therefore, the two wing sections 3002 of the elastic contact section 300 is limited to only be able to elastically move in the slit 2465 between the two pairs of upper blockers 2461 and lower blockers 2463 of the first terminal set passage 242. In other words, the elastic contact section 300 of the first terminal set 30 will not extend to overpass the mating surface 240 of the mating part 24. At the same time, the lower surface of the first terminal set 30 is exposed below the base part 22 and below the mating part 24 along the direction of extension of the first terminal set passage 242, wherein the soldering pin section 306 by way of the vertical wall surface 2221 of the recessed portion 222 of the base part 22 extends and overpasses the horizontal surface wall 2223.

As shown in FIGS. 1B and 1D, when the second terminal set 40 is configured to the second terminal set passage 244, the second terminal set 40 is loaded into the plurality of second terminal set passages 244 from the top of the mating surface 240 of the insulation body 20 and from the top of the base part 22. Then, the plurality of vertically directional holding sections 404 and 406 are respectively inserted and fixed into the plurality of vertically directional second terminal set passages 244 in front and behind the base part 20, such that the elastic contact section 400 of the second terminal set 40 extends and overpasses the mating surface 240 of the mating part 240. The distribution position of the elastic contact section 300 of the first terminal set 30 is closer to the front end 246 of the mating part 24 than the distribution position of the elastic contact section 400 of the second terminal set 40. At the same time, the upper surface of the second terminal set 30 is exposed above the base part 22 and above the mating surface 240 along the direction of extension of the second terminal set passage 244. The soldering pin section 408 extends downward and overpasses the horizontal wall surface 2223 of the recessed portion 222 of the base part 22.

As shown in FIGS. 1A and 1D, the positioning part 50 is a plate structure having two sides forming a pair of wedge blocks 54. The wedge blocks 54 are used for fastening into cavities (not shown) on the horizontal wall surface 2223 of the recessed portion 222 such that the positioning part 50 is installed in the spaced formed in the recessed portion 222. In addition, a plurality of holes 52 are formed on the positioning part 50 for the solder section 306 of the first terminal set 30 and the solder section 408 of the second terminal set 40 to pass through and be properly positioned.

As shown in FIGS. 1A and 1D, when a USB 3.0 compliant complementary electrical connector is inserted into and is electrically connected to the electrical connector 1, the corresponding terminals (not shown) of the USB 3.0 complementary electrical connector will be pressed against the elastic contact section 300 of the first terminal set 30 in the mating surface 240. Similar to the mentioned elastic arm structure, the elastic support section 302 of the first terminal set 30 will provide the right side of the elastic contact section 300 of the first terminal set 30 the required elasticity. In this manner, the elastic contact section 300 of the first terminal set 30 may elastically move within the first terminal set passage 232. In an embodiment, since the upper blocker 2461 of the first terminal set passage 242 is used for blocking upward movement of the wing section 3002 in the first terminal set passage 232, the elastic movement distance in the upward direction by the elastic contact section 300 of the first terminal set 30 may be limited. For example, once the USB 3.0 compliant complementary electrical connector is unplugged from the electrical connector 1, the elastic contact section 300 of the first terminal set 30 will not extend to overpass the mating surface 240 as a result of the rebounding effect from pressure release since the upper blocker 2461 will limit the elastic movement in the upward direction. The lower blocker 2463 may be used to block the downward movement of the wing section 3002 such that the downward elastic movement distance “D1” of the elastic contact section 300 of the first terminal set 1 can be limited. Therefore, when the corresponding terminals of the USB 3.0 complementary electrical connector is inserted into the electrical connector 1 and presses against the elastic contact section 300 of the first terminal set 30, the elastic contact section 300 of the first terminal set 30 will not sustain any damage as a result of too much pressure being placed on it by the corresponding terminals of the USB 3.0 compliant complementary electrical connector.

As shown in FIGS. 1C and 1D, it should be noted that since the elastic contact section 300 of the first terminal set 30 is accommodated within the slit 2465 of the first terminal set passage 242, when the electrical connector 1 of the present invention is not electrically connected to any complementary electrical connectors, the elastic contact section 300 is connected against the bottom of the upper blocker 2461 and will not extend to overpass the mating surface 240. As a result, when a USB 2.0 compliant complementary electrical connector is inserted into and electrically connected to the second terminal set 40 of the electrical connector 1, the problem of the USB 2.0 compliant complementary electrical connector striking the first terminal set 30 will not occur.

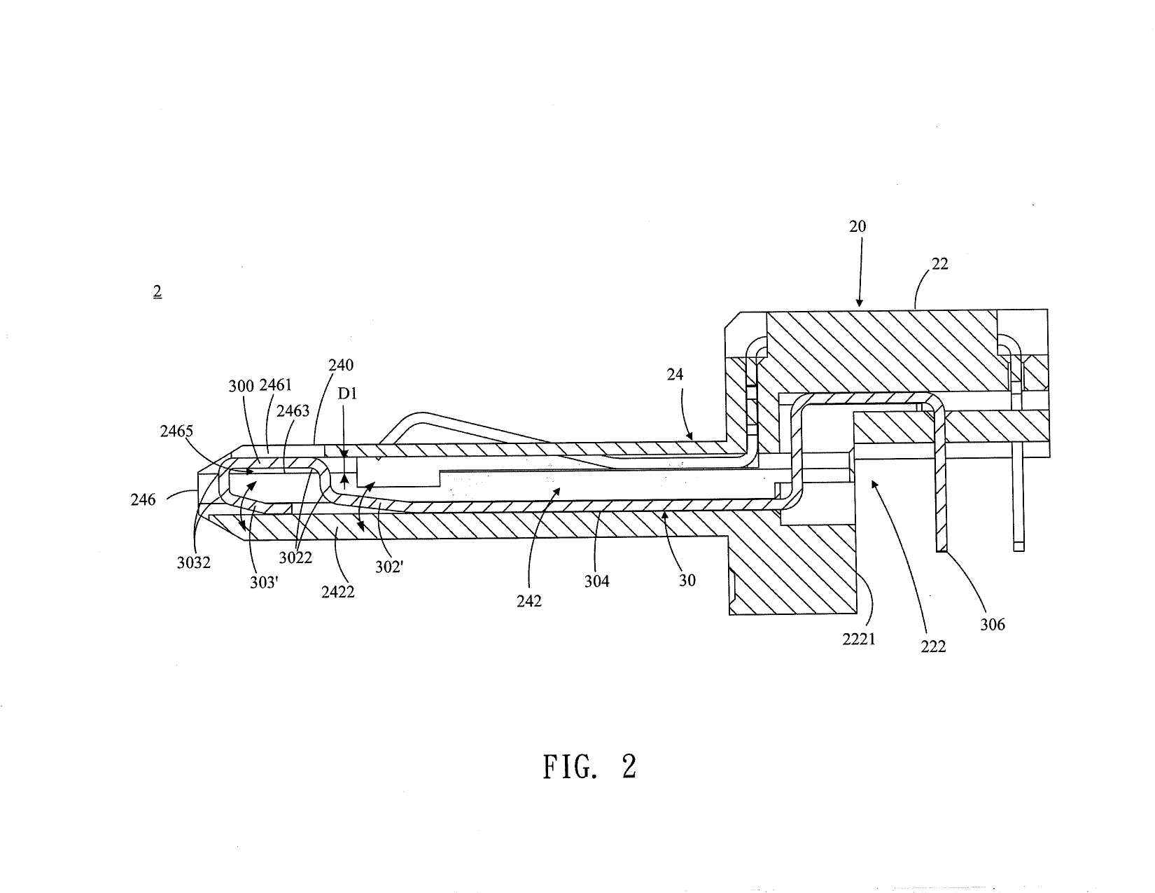

In reference to FIG. 2, a second embodiment of the electrical connector 2 of the present invention is shown. In comparison to the embodiment of the electrical connector 1, the electrical connector 2 differs in that each terminal of the first terminal set 30 of the electrical connector 2 have an elastic contact section 300, a first elastic support section 302′, a second elastic support section 303′, a plurality of horizontal holding sections 304, and a plurality of vertical soldering pin sections 306. The front of the first elastic support section 302′ is connected to the elastic contact section 300 and a plurality of bends 3022 are formed at that connection to the elastic contact section 300, while the back of the first elastic support section 302′ is connected to the plurality of holding sections 304. The front of the second elastic support section 303′ is connected to the elastic contact section 300 and a plurality of bends 3032 is formed at that connection to the elastic contact section 300. At least one bend 3032 is exposed at the front end 246 of the mating part 24 of the insulation body 20. Since a bottom end of the second elastic support section 303′ is preloaded and connected against the wall surface of a passage wall 2422 of the first terminal set passage 242, not only will the first elastic support section 302′ provide the right side of the elastic contact section 300 the required elasticity, the second elastic support section 303′ can provide elasticity to the left side of the elastic contact section 300. In this manner, the first elastic support section 303′, the elastic contact section 300, and the second elastic support section 303′ form a mechanical structure akin to forming a simple support beam in civil engineering, wherein the deflection rate is smaller in comparison to that of the mentioned first embodiment such that the structure is not easy to deform. Due to this fact, the two sides of the elastic contact section 300 of the first terminal set 30 can more stably elastically move within the first terminal set passage 242. It should be noted that the left and right side of the elastic contact section 300 referred herein pertains to the left and right sides of the diagram of the cross section A1-A1′ of FIG. 1D. Hence, in FIG. 2, the left and right sides of the elastic contact section 300 refers to the direction towards the front end 246 and the direction towards the base part 22 relative to the elastic contact section 300. In addition, as shown in FIG. 2, the design of the first terminal set passage 242 of the electrical connector 2 of the second embodiment passing through the recessed portion 222 of the insulation body 20, and the passage wall 2422 formed under the first terminal set passage 242, are different from the first embodiment. This allows the first terminal set 30 of the electrical connector 2 of the second embodiment to come directly to an end after the insulation body 20 (in comparison to front end 246). In other words, the first terminal set 30 may be inserted from on top of the vertical wall surface 2221 of the recessed portion 222 and disposed in the first terminal set passage 242. In terms of other positions and components, since they are the same as the first embodiment (such as the two opposite sides of the elastic contact section 300 of the first terminal set 20 respectively extend outward to form two wing sections—not shown—that are positioned between two pairs of upper and lower blockers 2461, 2463), they will not be further discussed here.

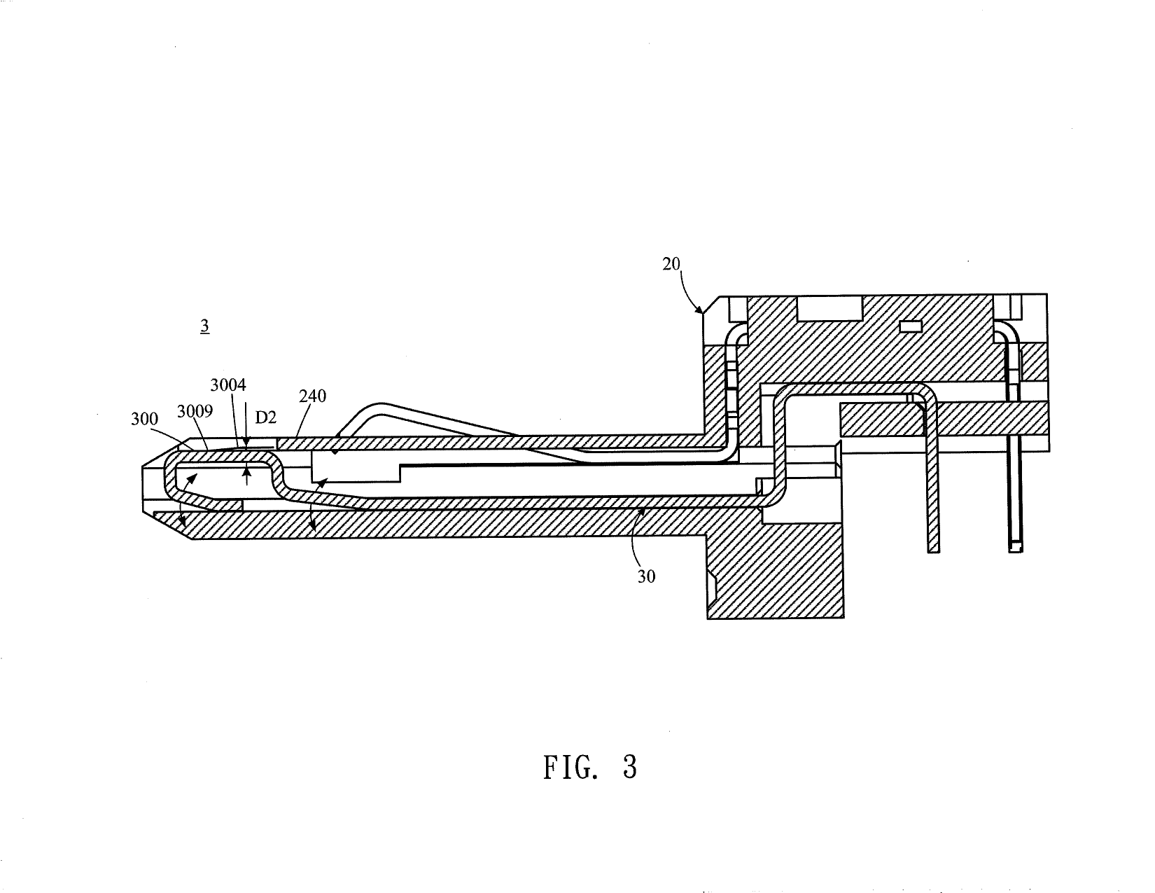

FIG. 3 illustrates a third embodiment of the electrical connector 3 of the present invention. In comparison to the electrical connector 2 of the second embodiment, the first terminal set 30 of the third embodiment also includes an elastic slice section 3004 punched or stamped upward from the elastic contact section 300 such that a bend 3009 is formed at the connection between the elastic slice section 3004 and the elastic contact section 300. The elastic slice section 3004 extends towards but not overpasses the mating surface 240 of the insulation body 20. In this manner, the elastic movement distance D2 may be increased (i.e. D2>D1) to provide higher contact elasticity when the electrical connector 3 is plugged.

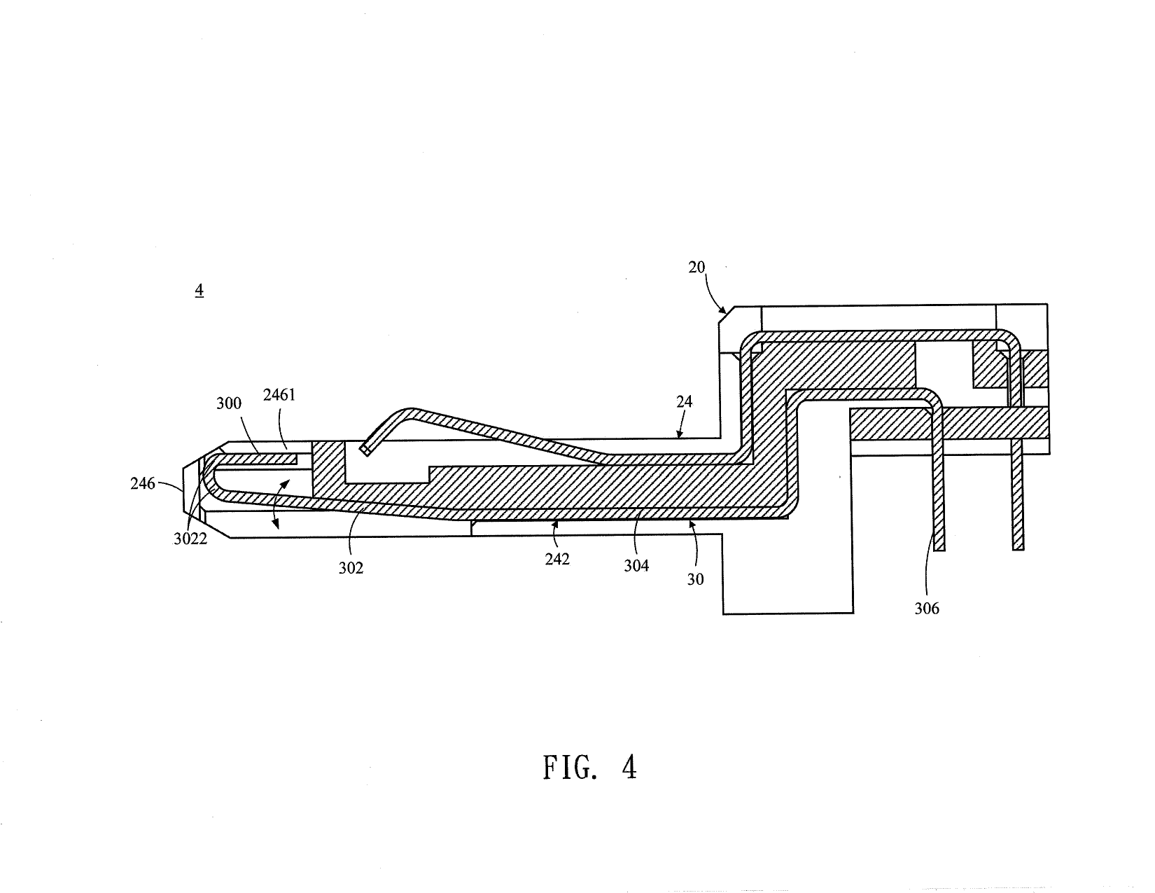

FIG. 4 illustrates a fourth embodiment of the electrical connector 4 of the present invention. In comparison to the electrical connector 1 of the first embodiment, each terminal of the first terminal set 30 has an elastic contact section 300, an elastic support section 302, a plurality of horizontal holding sections 304, and a vertical soldering pin section 306. The front of the elastic support section 302 is connected to the elastic contact section 300, wherein a plurality of bends 3022 is formed at that connection to the elastic contact section 300. At least one of the bends 3022 is exposed at the front end 246 of the mating part 24 of the insulation body 20. The back of the elastic support section 302 is connected to the plurality of holding sections 304. The elastic contact section 300 utilizes the wing sections on its two sides (not shown) to contact against the upper blocker (not shown) of the first terminal set passage 242. In other embodiments, the elastic contact section 300 may also utilize wing sections to be preloaded on the upper blocker of the first terminal set passage 242. The mechanical structure formed from the components between the elastic support section 302 to the elastic contact section 300 is akin to forming a cantilever that can move up and down. In terms of other parts and components, since they are the same as the first embodiment, they will not be further discussed here.

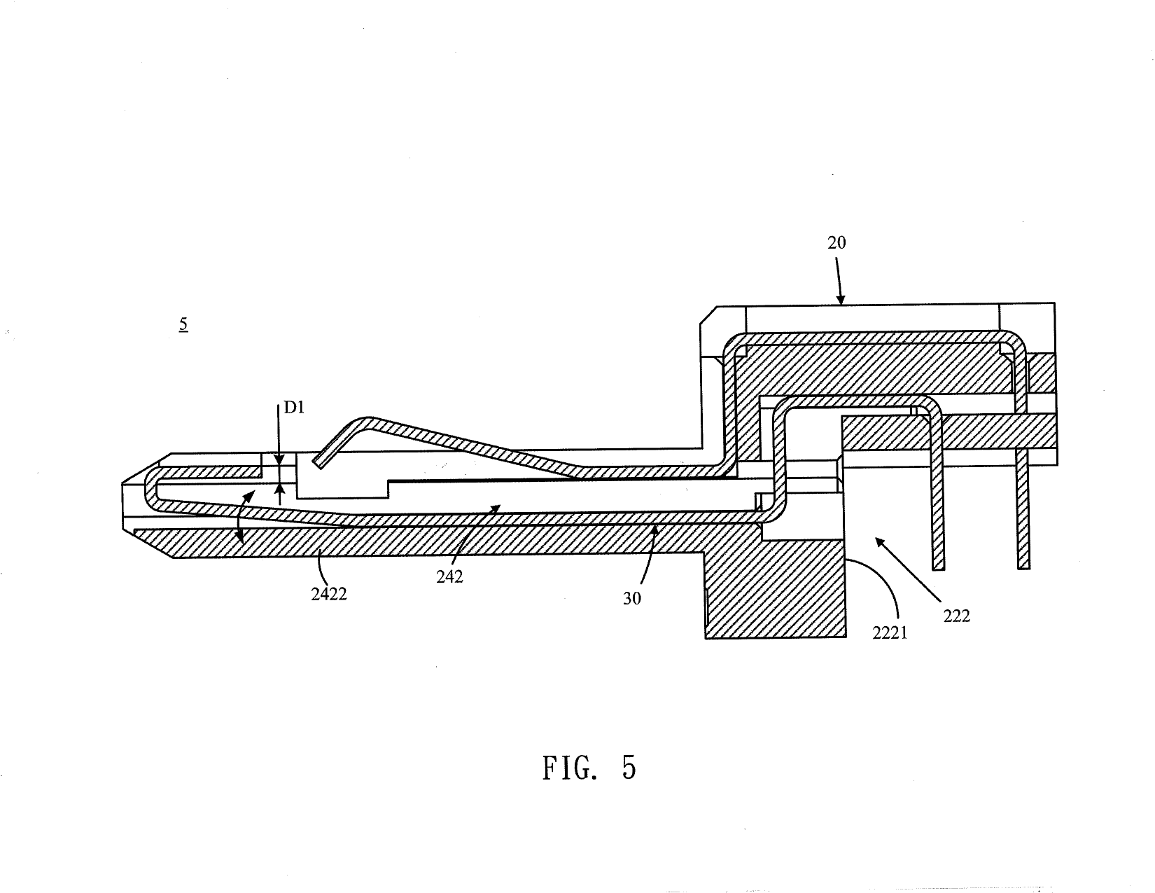

FIG. 5 illustrates a fifth embodiment of the electrical connector 5 of the present invention. In comparison to the electrical connector 4 of the fourth embodiment, the design of the first terminal set passage 242 of the electrical connector 5 passing through the recessed portion 222 of the insulation body 20, and the design of the passage wall 2422 being formed below the first terminal set passage 242 are different from the fourth embodiment. The first terminal set 30 of the electrical connector 5 can be directly inserted and disposed in the first terminal set passage 242 through the vertical wall surface 2221 of the recessed portion 222 of the insulation body 20. In terms of other parts and components, since they are the same as the fourth embodiment, they will not be further discussed here.

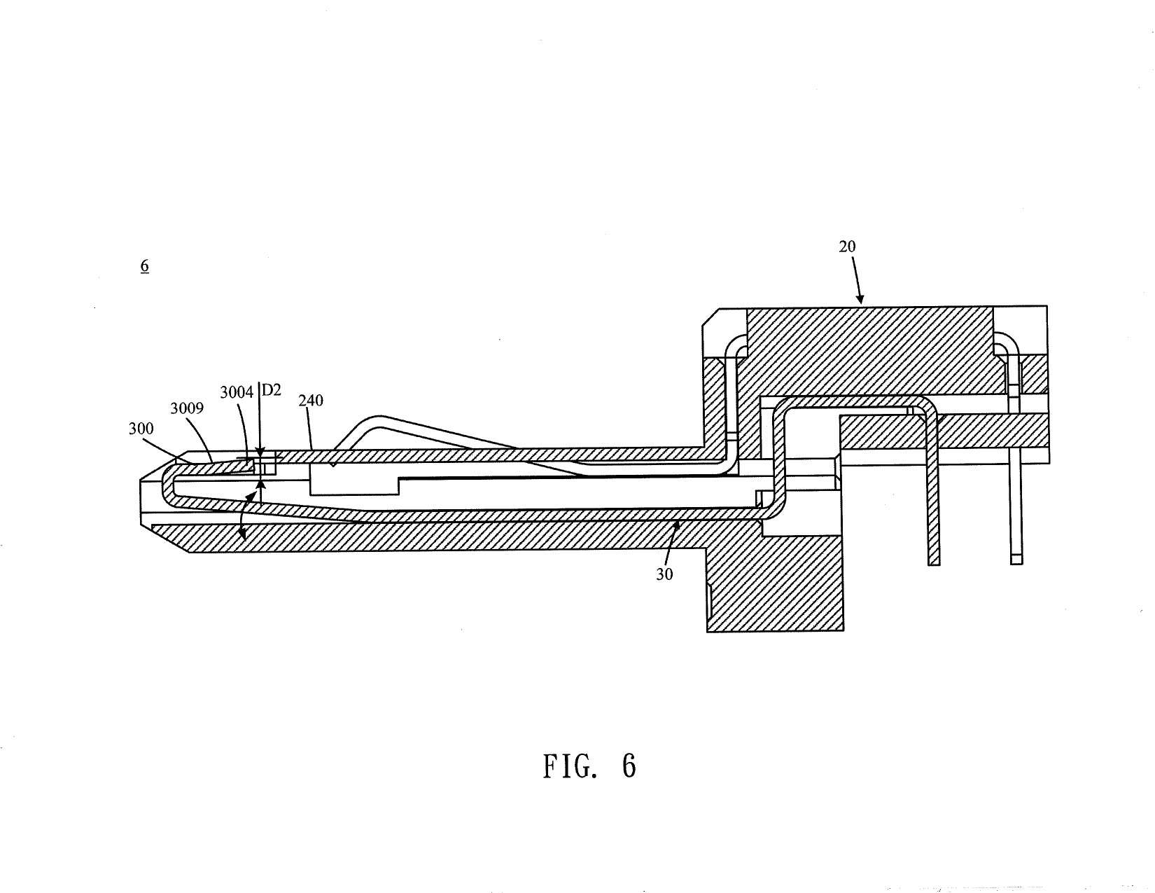

FIG. 6 illustrates a sixth embodiment of the electrical connector 6. In comparison to the electrical connector 5 of the fifth embodiment, the first terminal set 30 of the electrical connector 6 also includes an elastic slice section 3004, which is punched or stamped upward in the elastic contact section 300 such that a bend 3009 is formed at the connection between the elastic slice section 3004 and the elastic contact section 300. The elastic slice section 3004 extends toward but does not overpass the mating surface 240 of the insulation body 20. In this manner, the elastic movement distance D2 may be increased (i.e. D2>D1) to provide higher contact elasticity when the electrical connector 6 is plugged.

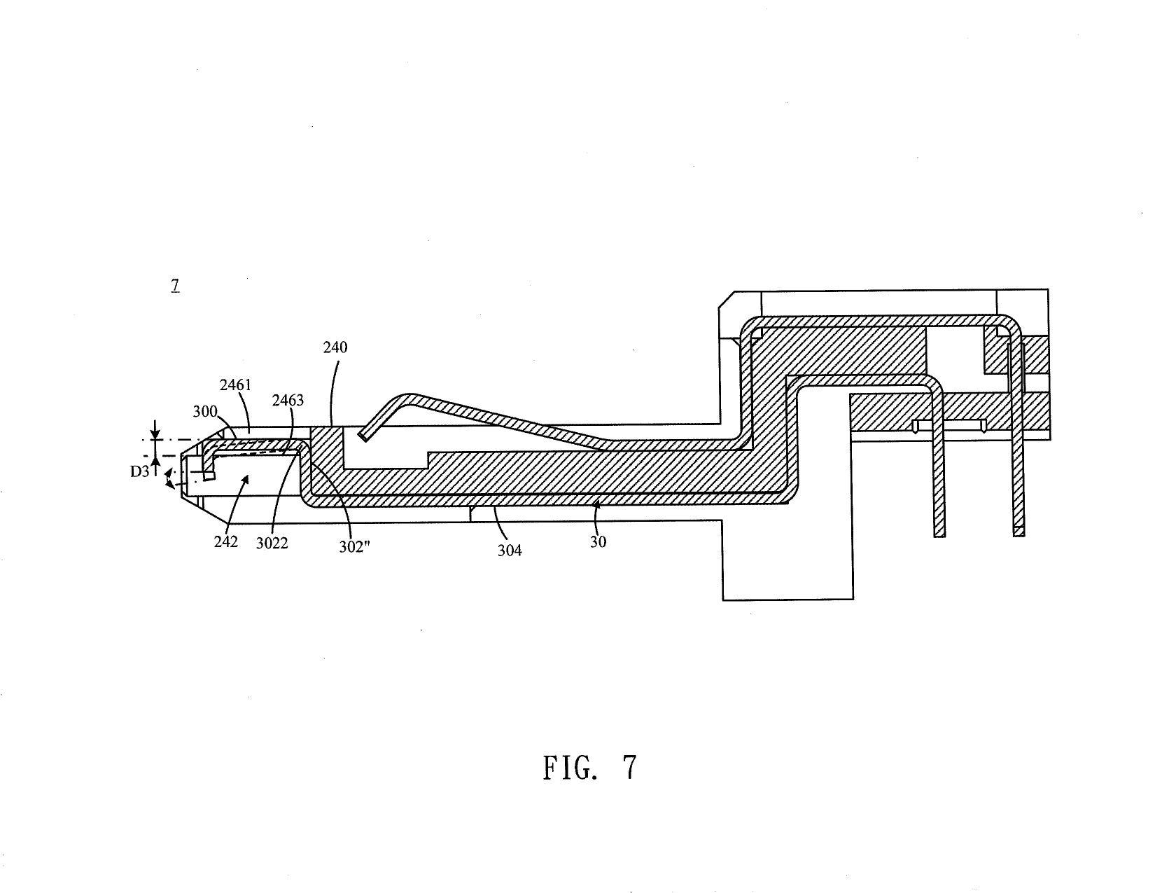

FIG. 7 illustrates a seventh embodiment of the electrical connector 7. In comparison to the electrical connector 1 of the first embodiment, each terminal of the first terminal set 30 of the electrical connector 7 has an elastic contact section 300 and a non-elastic support section 302″, wherein the non-elastic support section 302″—without making elastic deformation—and the holding section 304 are nearly orthogonal connected and the non-elastic support section 302″ is also nearly orthogonal connected with the elastic contact section 300. At least one bend 3022 is formed on the orthogonal connection between the elastic contact section 300 and the non-elastic support section 302″, wherein at least one bend 3022 is abut against the lower blocker 2463 of the first terminal set passage 242. When a complementary electrical connector is electrically connected to the electrical connector 7 and presses against the elastic contact section 300 of the first terminal set 30, the elastic contact section 300 will utilize the connection between the elastic contact section 300 and the non-elastic support section 302″ (i.e. bend 3022) as a pivot fulcrum to elastically move a specific distance D3 within the first terminal set passage 242. However, since the wing sections (not shown) of the two sides of the elastic contact section 300 of the first terminal set 30 is limited or restricted between the upper and lower blockers 2461, 2463 of the first terminal set passage 242, the upper and lower blockers 2461, 2463 will limit the movement of the wing section of the first terminal set 30 in a vertical direction. In this manner, the upward and downward elastic movement distance D3 of the elastic contact section 300 of the first terminal set 30 is limited. At the same time, the lower blocker 2463 also limits the movement of the non-elastic support section 302″ of the first terminal set 30 in a horizontal direction.

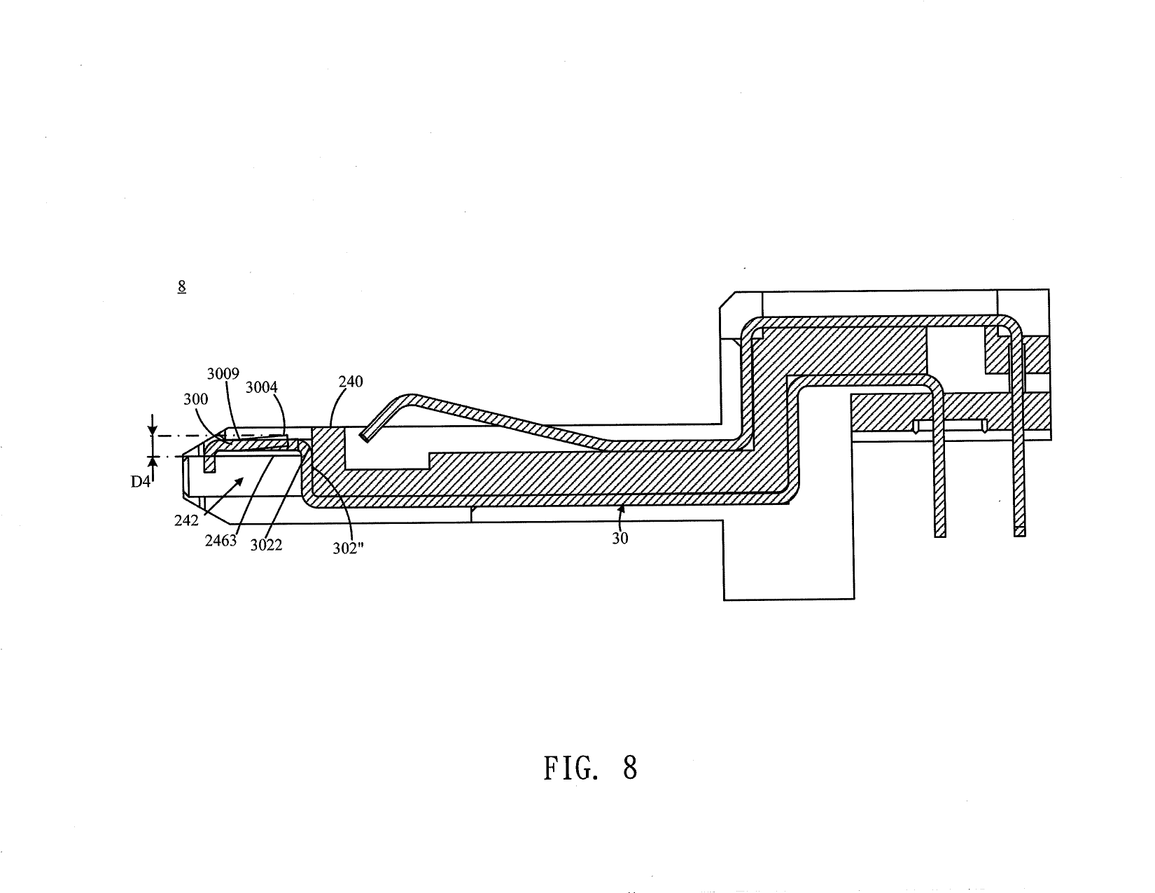

FIG. 8 illustrates an eight embodiment of the electrical connector 8. In comparison to the electrical connector 7 of the seventh embodiment, the first terminal set 30 of the electrical connector 8 also includes an elastic slice section 3004 that is punched or stamped upward in the elastic contact section 300 such that a bend 3009 is formed at the connection between the elastic slice section 3004 and the elastic contact section 300. The elastic slice section 3004 extends towards but not overpasses the mating surface 240 of the insulation body 20. In this manner, the elastic movement distance D4 may be increased (i.e. D4>D3) such that higher contact elasticity may be provided when the electrical connector 8 is plugged.

According to another embodiment of the present invention, an electronic device is provided with the mentioned embodiments of the electrical connector 1, 2, 3, 4, 5, 6, 7, and 8 installed therein. The electronic device may include laptop computers, tablet computers, mobile phones, digital cameras, handheld storages, and the like.

In addition, according to a ninth embodiment of the present invention, an assembling method of the electrical connector is provided. To facilitate better understanding of the assembling method, please refer to FIGS. 1A-1D of the electrical connector 1 of the first embodiment. The assembling method includes the following steps:

From a front to back direction, the first terminal set 30 is respectively loaded into the plurality of first terminal set passages 242 from the front end 246 of the insulation body 20.

Then, the holding section 304 of the first terminal set 30 is fixed within the first terminal set passage 242 underneath the insulation body 20 such that the elastic support section 302 of the first terminal set 30 is positioned in the first terminal set passage 242. The position of the elastic contact section 300 of the first terminal set 30 is distributed on the mating surface 240 of the mating part 24 near the front end 246. In addition, the elastic contact section 300 of the first terminal set 30 is accommodated in the slit 2465 of the first terminal set passage 242, wherein the two wing sections 3002 of the elastic contact section 300 lies between the upper and lower blockers 2461, 2463 (ex. wing section 3002 pressing against the bottom of the upper blocker 2461). The mechanical structure formed between the elastic support section 302 and the elastic contact section 300 is akin to forming a cantilever structure. The elastic support section 302 will provide the left side of the elastic contact section 300 the required elasticity. Since the two wing sections 3002 of the elastic contact section 300 is limited to only be able to elastically move in the slit 2465 between pairs of the upper and lower blockers 2461, 2463 within the first terminal set passage 242. Therefore, the elastic contact section 300 of the first terminal set 30 will not extend overpasses the mating surface 240 of the mating part 24. The soldering pin section 306 extends along the vertical wall surface 2221 of the recessed portion 222 of the base part 22 and overpasses the horizontal wall surface 2223.

From a top to bottom direction, the second terminal set 40 is loaded into the plurality of second terminal set passages 244 from the above of the base part 20 and the mating surface 240 of the insulation body 20. Then, the plurality of vertical holding sections 404 and 405 of the second terminal set 40 is separately inserted and fixed in the front and back vertical second terminal set passages 244. The elastic contact section 400 of the second terminal set 40 extends outward and overpasses the mating surface 240 of the mating part 24, wherein the distribution position of the elastic contact section 300 of the first terminal set 30 is closer to the front end 246 of the mating part 24 than the distribution position of the elastic contact section 400 of the second terminal set 40 (as shown in FIG. 1B). In this instance, the top surface of the second terminal set 30 is exposed along the direction of extension of the second terminal set passage 244 on the base part 22 and on the mating surface 240. The soldering pin sections 408 extend downwards, overpassing the horizontal wall surface 2223 in the recessed portion 222 of the base part 22.

A pair of wedge blocks 54 of two opposites sides of the positioning part 50 is fastened to cavities (not shown) at two sides of the horizontal wall surface 2223 of the recessed portion 222 below the insulation body 20, such that the positioning part 50 is installed in the space formed by the recessed portion 222. In this instance, a plurality of sockets 52 of the positioning part 50 is used for letting the soldering pin section 306 of the first terminal set 30 and the soldering pin section 408 of the second terminal set 40 to pass through and to be positioned.

The insulation body 20 is accommodated in the accommodating space 12 of the shielding housing 10. Hooks 14 on two side wall surfaces of the shielding housing 10 are used to correspondingly to the left and right two sides of the base part 22 of the insulation body 20 so that the shielding housing 10 can be sleeved onto the insulation body 21.

In addition, according to a tenth embodiment of the present invention, an assembling method for an electrical connector is provided. To facilitate better understanding of the assembling method of the tenth embodiment, please refer to FIG. 2 of the electrical connector 2 of the second embodiment. The differences in the assembling method of the tenth embodiment in comparison to the ninth embodiment is described in the following steps:

From a back to front direction, the first terminal set 30 is respectively inserted and disposed into the plurality of first terminal set passages 242 from the back end of the insulation body 20 (i.e. at the vertical wall surface 2221 of the recessed portion 222 opposite the front end 246). Then, the holding section 304 is fixed in the first terminal set passage 242 below the insulation body 20, wherein the position of the elastic contact section 300 of the first terminal set 30 is distributed on the mating surface 240 of the mating part 24 close to the front end 246. In this instance, the elastic contact section 300 of the first terminal set 30 is accommodated in the slit 2465 of the first terminal set passage 242. The two wing sections (not shown) of the elastic contact section 300 lies between the upper blocker 2461 and the lower blocker 2463 within the first terminal set passage 242. At least one bend 3032 formed at the connection between the elastic contact section 300 and the second elastic support section 303′ is exposed at the front end 246 of the mating part 24 of the insulation body 20. Since the bottom end of the second elastic support section 303′ is preloaded and connected against the wall surface of the passage wall 2422 of the first terminal set passage 242, elasticity can be provided to the left side of the elastic contact section 300. In this manner, through the mechanical structure formed as an upward-downward moving cantilever between the first elastic support section 302′, the elastic contact section 300, and the second elastic support section 303′, the two sides of the elastic contact section 300 of the first terminal set 30 may more stably move within the first terminal set passage 242. In terms of the other steps, since they are the same as the ninth embodiment, they will not be further discussed here.

In addition, according to an eleventh embodiment of the present invention, an assembling method for an electrical connector is provided. To facilitate better understanding of the assembling method of the tenth embodiment, please refer to FIG. 4 of the electrical connector 4 of the second embodiment. The differences in the assembling method of the eleventh embodiment in comparison to the fourth embodiment is described in the following steps:

After the first terminal set 30 is loaded into the plurality of first terminal set passages 242, the at least one bend 3022 formed at the connection between the elastic support section 302 and the elastic contact section 300 is exposed at the front end 246 of the insulation body 20 while providing the required elasticity for the left side of the elastic contact section 300. In terms of the other steps, since they are the same as the ninth embodiment, they will not be further discussed here.

In addition, according to a twelfth embodiment of the present invention, an assembling method for an electrical connector is provided. To facilitate better understanding of the assembling method of the tenth embodiment, please refer to FIG. 5 of the electrical connector 5 of the second embodiment. The differences in the assembling method of the eleventh embodiment in comparison to the fourth embodiment is described in the following steps:

Along a back to front direction, the first terminal set 30 is respectively inserted and disposed within the first terminal set passages 242 from the back end of the insulation body 20 (i.e. vertical wall surface 2221 of the recessed portion 222). In terms of the other steps, since they are the same as the eleventh embodiment, they will not be further discussed here.

In addition, according to a thirteenth embodiment of the present invention, an assembling method for an electrical connector is provided. To facilitate better understanding of the assembling method of the tenth embodiment, please refer to FIGS. 7-8 of the electrical connectors 7 and 8 of the seventh and eighth embodiments. The differences in the assembling method of the eleventh embodiment in comparison to the ninth embodiment is described in the following steps:

When loading the first terminal set 30 into the plurality of first terminal set passages 242, the non-elastic support section 302″ is fixedly connected against the lower blocker 2463 on the wall surface of the first terminal set passage 242 to form a non-elastic support section. By utilizing an orthogonal connection, such as the bend 3022, between the non-elastic support section 302″ and the elastic contact section 300 of the first terminal set 30, a rotational fulcrum is formed such that the elastic contact section 300 of the first terminal set 30 may elastically move within the first terminal set passage 242. In terms of the other steps, since they are the same as the ninth embodiment, they will not be further discussed here.

In summary of the above, the electrical connector and the electronic device including the electrical connector of the present invention can not only simplify the insulation body to decrease the usage quantity of molds to lower manufacturing costs, each terminal structure also includes an elastic contact section and at least one elastic/non-elastic support section. When the corresponding terminals of a complementary electrical connector are electrically contacting the elastic contact section, the at least one elastic/non-elastic support section can provide better contact elasticity or flexibility to prevent the terminals structure from sustaining damage. As well, according to the assembling method of the electrical connector of the present invention, through the simplification of the insulation body, the assembling is easier, which results in higher product yields and decreased manufacturing costs.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An electrical connector for electrically connecting with a complementary electrical connector, comprising:
a first terminal set having a pair of first differential signal terminals and a pair of second differential signal terminals;
a second terminal set having a pair of third differential signal terminals, wherein each terminal of the first terminal set and the second terminal set has an elastic contact section and at least one elastic support section connected to the elastic contact section; and
an insulation body having a base part and a mating part that extends outward from the base part to an end, a mating surface is formed on the mating part to correspond to connection with the complementary electrical connector, and the insulation body has a plurality of first terminal set passages and a plurality of second terminal set passages to be respectively configured with the first terminal set and the second terminal set such that the elastic contact section of the first terminal set and the elastic contact section of the second terminal set are distributed on the mating surface of the mating part, wherein the elastic contact section of the first terminal set is disposed near the end of the mating part;
wherein at least one of the elastic support section of the first terminal set produces corresponding elastic deformation to provide elasticity for the elastic contact section of the first terminal set, and the elastic contact section of the first terminal set elastically moves in the first terminal set passage.

2. The electrical connector of claim 1, further comprising a positioning part disposed in the base part, and the first terminal set and the second terminal set have at least one holding section and a soldering pin section, wherein the at least one holding section is used for respectively securing the first terminal set or the second terminal set within the first terminal set passage and the second terminal set passage of the insulation body, and the soldering pin section extends outward from the base part of the insulation body and passes through the positioning part.

3. The electrical connector of claim 1, wherein the first terminal set passage and the second terminal set passage both extend to the base part and the mating part of the insulation body, and the first terminal set passage passes through an end of the mating part..

4. The electrical connector of claim 1, wherein the at least one elastic support section of the first terminal set is located in the first terminal set passage when the first terminal set passage is configured with the first terminal set, and a bend is formed in a connection between the at least one elastic support section and the elastic contact section forms at least one bend.

5. The electrical connector of claim 4, wherein the first terminal set includes an elastic slice section, the elastic slice section is bent towards the mating surface of the insulation body and is used for contacting the complementary electrical connector.

6. The electrical connector of claim 4, wherein the at least one bend is exposed outside the end of the mating part of the insulation body.

7. The electrical connector of claim 4, wherein the at least one elastic support section of the first terminal set includes a first elastic support section and a second elastic support section, the second elastic support section is preloaded to be compressed and contacting with a passage wall of the first terminal set passage, and the at least one bend includes a first bend and a second bend, the first bend is formed between connection of the first elastic support section and the elastic contact section, and the second bend is formed between a connection of the second support section and the elastic contact section.

8. The electrical connector of claim 1, wherein a side of each elastic contact section of the first terminal set extends outward to form at least one wing section, and at least one inner sidewall of each of the first terminal set passage forms at least one blocker to correspond to the at least one wing section, and the corresponding at least one blocker of the first terminal set is used for blocking movement of the at least one wing section of the first terminal set when the first terminal set is accommodated in the corresponding first terminal set passage so as to limit upward or downward elastic movement distance of the elastic contact section.

9. The electrical connector of claim 8, wherein the at least one blocker includes an upper blocker and a lower blocker, the upper blocker is used for blocking the at least one wing section from moving upwards so as to limit the elastic movement distance in an upward direction of the first terminal set, and the lower blocker is used for blocking the at least one wing section from moving downwards so as to limit the elastic movement distance in an downward direction of the first terminal set.

10. An electrical connector, comprising:
a first terminal set having a pair of first differential signal terminals and a pair of second differential signal terminals;
a second terminal set having a pair of third differential signal terminals, wherein each terminal of the first terminal set and the second terminal set has an elastic contact section and at least one support section connected to the elastic contact section; and
an insulation body having a base part and a mating part that extends outward from the base part to an end, a mating surface is formed in the mating part and the insulation body has a plurality of first terminal set passages and a plurality of second terminal set passages to be respectively configured with the first terminal set and the second terminal set such that the elastic contact section of the first terminal set and the elastic contact section of the second terminal set are distributed on the mating surface of the mating part, wherein the elastic contact section of the first terminal set is disposed near the end of the mating part, and the elastic contact section of the first terminal set elastically moves in the first terminal set passage by utilizing connection between the elastic contact section and the at least one support section as a fulcrum.

11. The electrical connector of claim 10, wherein the elastic contact section is located in the first terminal set passage when the first terminal set passage is configured with the first terminal set, and a bend is formed in a connection between the at least one elastic support section and the elastic contact section forms at least one bend.

12. The electrical connector of claim 10, wherein a portion of the at least one support section of the first terminal set is fixed in the first terminal set passage.

13. The electrical connector of claim 10, wherein the first terminal set includes an elastic slice section wherein the elastic slice section is bent toward the mating surface of the insulation body, and is used for connecting to a complementary electrical connector.

14. The electrical connector of claim 10, wherein a side of each elastic contact section of the first terminal set extends outward to form at least one wing section, and at least one inner sidewall of each of the first terminal set passage forms at least one blocker to correspond to the at least one wing section, the at least one blocker of the corresponding first terminal set passage is used for limiting the movement of at least one wing section of the first terminal set in a vertical direction such that the elastic contact section of the first terminal set is limited in an upward or downward elastic movement distance, and the at least one blocker limits the movement of at least one elastic support section of the first terminal set in a horizontal direction.

15. An electronic device, comprising the electrical connector of claim 1.

16. An electronic device, comprising the electrical connector of claim 10.

17. An assembly method of an electrical connector, comprising:
loading a first terminal set into a plurality of first terminal set passages of an insulation body, wherein the insulation body has a base part and a mating part extending outward from the base part to a first end and the a mating surface is formed in the mating part , the first set terminal has a pair of first differential signal terminals and a pair of second differential signal terminals; and
loading a second terminal set into a plurality of second terminal set passages of the insulation body, the second terminal set has a pair of third differential signal terminals, wherein each terminal of the first terminal set and the second terminal set has an elastic contact section and at least one support section that is connected to the elastic contact section, and the elastic contact section of the first terminal set is distributed on the mating surface of the mating part, and at least one support section of the first terminal set makes the elastic contact section of the first terminal set to elastically move in the first terminal set passage, and the elastic contact section of the second terminal set is distributed on the mating surface of the mating part, the elastic contact section of the first terminal set is relatively closer to the first end of the mating part than the elastic contact section of the second terminal set.

18. The assembly method of claim 17, wherein the at least one support section forms at least one elastic support section when loading each of the first terminal set or the second terminal set into the corresponding terminal set passages, and the at least one elastic support section is an elastic arm structure and a portion of the elastic arm structure leans against a wall surface of the first terminal set passage to provide elasticity.

19. The assembly method of claim 17, wherein when loading each of the first terminal set into the first terminal set passages, the at least one support section forms a non-elastic support section, the at least one support section fixedly leans against a wall surface of the first terminal set, and a fulcrum is formed in an connection between the at least one support section and the elastic contact section of the first terminal set to make the elastic contact section of the first terminal set to elastically move in the first terminal set passage.

20. The assembly method of claim 17, comprising:
loading the first terminal set into the plurality of first terminal set passages from first end of the insulation body, and loading the second terminal set into the plurality of second terminal set passages from the mating surface of the insulation body.

21. The assembly method of claim 18, comprising:
loading the first terminal set from a second end formed in the insulation body, corresponding to the first end, into the plurality of first terminal set passages, and loading the second terminal set from the mating surface of the insulation body into the plurality of second terminal set passages.
